(19) United States
(12) Patent Application Publication
(10) Pub. No.: US 2007/0213094 A1
(43) Pub. Date: Sep. 13, 2007

(54) Method and apparatus for a configurable processing and storage device

(75) Inventors: Kathy A. Kane, Rio Rancho, NM (US); Lance R. Atencio, Albuquerque, NM (US); Camilo F. Gomez, Albuquerque, NM (US)

Correspondence Address: INTEL CORPORATION;c/o INTELLEVATE, LLC, P.O. BOX 52050, MINNEAPOLIS, MN, 55402, US

(73) Assignee: INTEL CORPORATION

(21) Appl. No.: 11/373,221

(22) Filed: Mar. 9, 2006

(51) Int. Cl. H04M 1/00; H04B 1/38

(52) U.S. Cl. 455/557; 455/556.1

(57) ABSTRACT

Some embodiments of a method and system are described for configurable processing and storage device. The apparatus may include, in some embodiments, a housing to deploy a mobile processing environment including a processor module to execute one or more processes, wherein the processor module may include one or more cores; a transceiver to establish communication between the apparatus and a network; a communications module to control communication between the apparatus and the network; and an application environment to provide an interface to a client by request received on the network, wherein the interface may provide the client with an application operable on the apparatus without installing the application on the client and data retrieved from the apparatus. In some embodiments, the one or more processes may include the interface, the application, and/or requests to retrieve or modify the data. Other embodiments may be described.

### BACKGROUND

1. Technical Field

Some embodiments of the invention generally relate to mobile computer systems. More specifically, some embodiments relate to mobile processing and storage systems.

2. Discussion

In recent years, efforts have been made to increase the portability and operability of mobile devices. Increasingly, these devices have been reduced in size and/or designed to provide only a few specialized functions. These developments have limited the usability of the devices, and created an environment where users of mobile devices often have several devices.

Thus, in the conventional mobile environment, users have the difficult problem of maintaining several devices and trying to perform work and/or home tasks with devices that often do not interact with one another. Moreover, in other environments, such as in hospitals, public services, schools, and in some home and office environments, users are often using devices that do not interact with one another.

Therefore, there is a need for methods and systems that provide a mobile processing environment that provides a user with his/her data and applications regardless of the computer systems available to the user at a given location.

### BRIEF DESCRIPTION OF THE DRAWINGS

Various advantages of embodiments of the present invention will become apparent to one of ordinary skill in the art by reading the following specification and appended claims, and by referencing the following drawings, in which:

FIG. 1 illustrates a mobile processing environment, according to some embodiments of the invention;

FIG. 2 illustrates a mobile processing system, according to some embodiments of the invention;

FIG. 3 illustrates a flowchart for mobile processing, according to some embodiments of the invention; and

FIG. 4 illustrates a mobile processing system, client devices, and a user in a usage model, according to some embodiments of the invention.

### DETAILED DESCRIPTION

Reference is made to some embodiments of the invention, examples of which are illustrated in the accompanying drawings. While the invention will be described in conjunction with the embodiments, it will be understood that they are not intended to limit the invention to these embodiments. On the contrary, the invention is intended to cover alternatives, modifications and equivalents, which may be included within the spirit and scope of the invention as defined by the appended claims. Moreover, in the following detailed description of the invention, numerous specific details are set forth in order to provide a thorough understanding of the invention. However, the invention may be practiced without these specific details. In other instances, well-known methods, procedures, components and circuits have not been described in detail as not to unnecessarily obscure aspects of the invention.

Some embodiments of a method and system are described for a configurable processing and storage device. The apparatus may include, in some embodiments, a housing to deploy a mobile processing environment including a processor module to execute one or more processes, wherein the processor module may include one or more cores; a transceiver to establish communication between the apparatus and a network; a communications module to control communication between the apparatus and the network; and an application environment to provide an interface to a client by request received on the network, wherein the interface may provide the client with an application operable on the apparatus without installing the application on the client and data retrieved from the apparatus. In some embodiments, the one or more processes may include the interface, the application, and/or requests to retrieve or modify the data.

In some embodiments, the application may be created by the interface to conform to the requirements of the user. In other words, the user may create a user-programmable application through the interface based on one or more components or applets, as one of ordinary skill in the relevant art(s) would appreciate based on least on the teachings provided herein.

Some embodiments may include the network being or having access to the Internet, a cellular telephone network, a local area network, and/or a wide area network. Moreover, in some embodiments, the interface may provide a web server using at least hypertext markup language to converse with the client. Other embodiments are provided herein.

In some embodiments, the methods of the mobile processing environment may include: i) deploying a mobile processing environment in a housing including a processor module to execute one or more processes, wherein the processor module includes one or more cores; ii) establishing communication with a transceiver between the apparatus and a network; iii) controlling communication to the network with a communications module at the apparatus; and iv) providing an application environment with an interface to a client by request received on the network, wherein the interface provides the client with an application operable on the apparatus without installing the application on the client and data retrieved from the apparatus. Additional embodiments and alternative methods are provided herein.

Indeed, reference in the specification to an embodiment or some embodiments of the invention means that a particular feature, structure or characteristic described in connection with the embodiment is included in at least one embodiment of the invention. Thus, the appearances of the phrase “in some embodiments” or “according to some embodiments” appearing in various places throughout the specification are not necessarily all referring to the same embodiment.

In some embodiments, the invention may be a portable or mobile device that provides users with the capability to carry their primary data and application(s) with them anywhere they go, and connect to other computer devices, referred to as clients when they connect to the mobile device, for data sharing and application processing.

The mobile devices may have components which are hardware and software. For example, in some embodiments, the hardware components may be a memory, a processor, and a communications module. In some embodiments, the mobile devices may have software components including a memory manager may provide the user with a place to store data and applications which can be accessed from a client via a network.

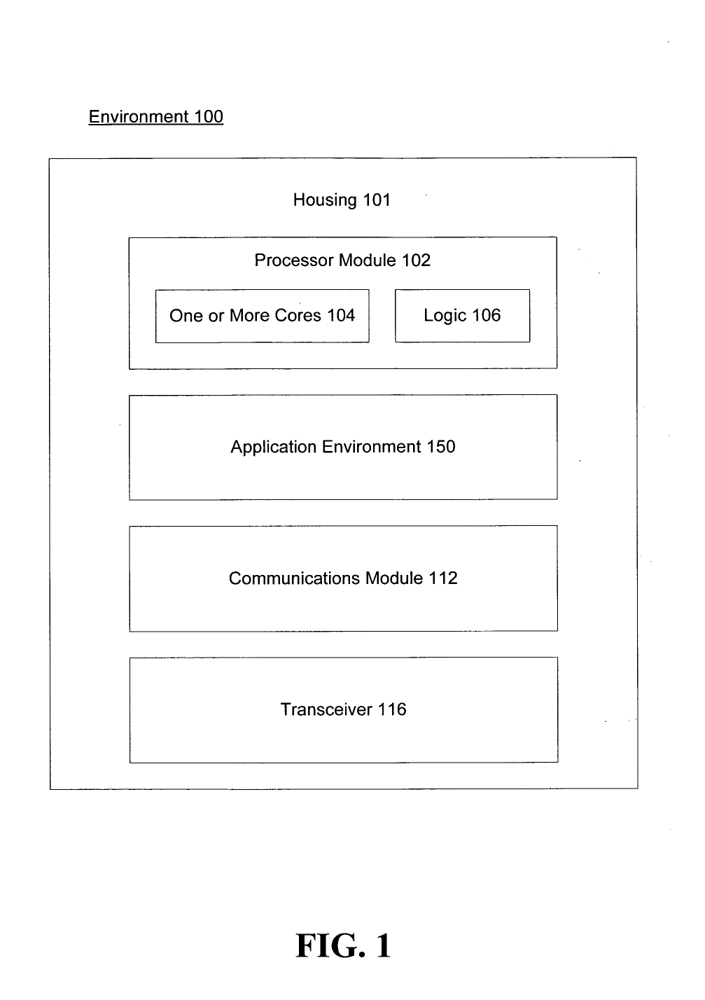

FIG. 1 illustrates a mobile processing environment 100, according to some embodiments of the invention. The environment 100 may include, according to some embodiments, a housing 101 to house a processor module 102, an application environment 150, a communications module 112, and a transceiver 116. In some embodiments, the processor module may include one or more cores 104, and logic 106. In some embodiments, the one or more cores 104 may include one or more execution cores/units. In some embodiments, the logic 106 may perform power management functions, as well as some of the functions of embodiments of the invention, as described herein.

The application environment 150 may be implemented in either hardware or software or firmware or an equivalent component, or in some combinations of these components. The application environment 150 may provide an interface to a client by request received on a network, in some embodiments; such as, but not limited to, a web browser execution environment that may utilize the components of the environment to provide a platform independent means of executing applications and accessing data on the mobile device. In some embodiments, the environment 150 may use hypertext markup language (HTML), lava programming languages, Net Framework (a Microsoft® Corporation product), or similarly enhanced services, as one of ordinary skill in the relevant arts would appreciate based at least on the teachings described herein.

Furthermore, in some embodiments, the environment 150 may be optimized to use several services at once, and may do so without the need of an abstraction layer, as one of ordinary skill in the relevant art would also appreciate based at least on the teachings described herein. In some embodiments, the interface provides the client with an application operable on the mobile device without installing the application on the client, thus reducing footprint and processing impact of the application to the mobile device, rather than the client.

The communications module 112, in some embodiments, may control communication between the mobile device and the clients on the network. The communications module may be coupled to the transceiver 116, in some embodiments. The transceiver 116 may establish communication between the mobile device and the network, providing the means to exchange information. As such, in some embodiments, the module 112 and transceiver 116, along with any input/output (I/O) ports (described elsewhere herein), may provide a means for the mobile device to connect with the clients and share data and processing capabilities.

In some embodiments, the client machine may be able to operate in a manner that offloads certain tasks to the mobile device, thus providing an increase in processing power and operating efficiency to the client, while also reducing the requirements of the client to perform those functions. For example, when a client is a personal digital assistant (PDA), it may not be able to perform some of the processing tasks that may be routine for the mobile device. In some embodiments, the client may be cellular telephone, a laptop computer, a desktop computer, or a network appliance. Furthermore, regardless of the form of the client, the offloading of tasks may increase the operational life of the battery-powered client, as well as reduce the heat generated by the client.

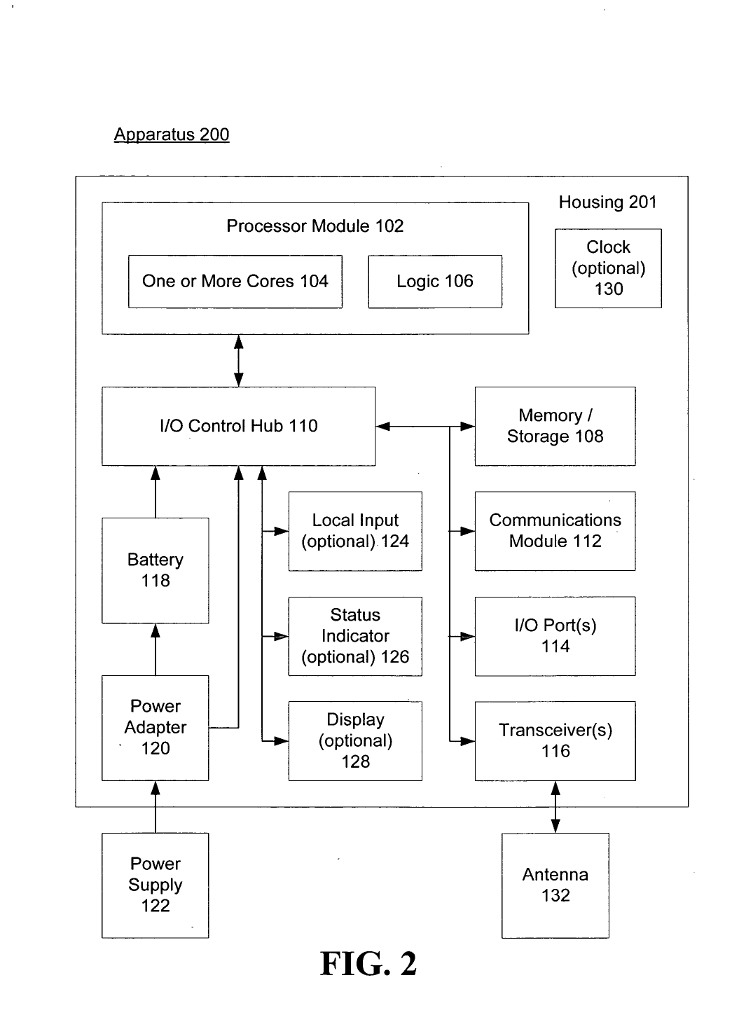

FIG. 2 illustrates a mobile processing apparatus 200, according to some embodiments of the invention. In some embodiments, the system or apparatus 200 may include a housing 201 to deploy a mobile processing environment including the processor module 102 to execute one or more processes, where the processor module 102 may include the one or more cores 104, and the logic 106. In some embodiments, a memory module 108 may provide storage for application(s) and data, as well as providing operating memory to enable the operations of the processor.

In some embodiments, the apparatus 200 may include an input/output (I/O) control hub (ICH) 110 to manage information transmitted to and received from the processor module. In some embodiments, the ICH 110 may coordinate the communication between the other components of the apparatus 200. As one of ordinary skill in the relevant art would appreciate, based at least on the teachings described herein, the ICH 110 may be one of the ICHX modules provided by Intel® Corporation, or a variant component designed specifically for the apparatus 200.

In some embodiments, the housing 201 may include a battery 118 to provide power to the apparatus 200. A power adapter 120 within the housing 201 may also be provided to power the apparatus 200 and/or recharge the battery 118, according to some embodiments. In such embodiments, the power adapter 120 may be capable of receiving power from an external power supply 122. In some embodiments, the external power supply 122 may be the power supply of one of the clients on the network.

In some embodiments, the apparatus 200 may also include transceiver(s) 116 to establish communication between the apparatus 200 and a network. In some embodiments, the network may be the Internet, a cellular telephone network, a local area network, and/or a wide area network. In some embodiments, an antenna 132 may be coupled to the transceiver(s) 116 to increase reception and transmission of the apparatus 200.

In some embodiments, the communications module 112 may control communication between the apparatus 200 and the network. According to some embodiments, the user may use the client to access and manage the apparatus 200; the communications module 112 may authenticate a user's identity prior to providing the interface of the environment 150.

More specifically, the apparatus 200 may include an application environment 150, which may be instantiated by the processor module 102 and operated in and out of memory 108, to provide the interface to the client by request received on the network. As such, in some embodiments, the interface may provide the client with an application operable on the apparatus 200 without installing the application on the client. Furthermore, it may provide the client with data retrieved from the apparatus 200.

In some embodiments of the invention, the one or more processes executed by the processor module 102 may include the interface, the application, and/or requests to retrieve or modify the data. Furthermore, in some embodiments, one or more components of the applications are downloadable to the client from the apparatus 200. As the apparatus 200 is able to transfer data, the interface may include a file transfer and/or synchronization interface, according to some embodiments.

In some embodiments, the application may be created by the interface to conform to the requirements of the user. In other words, the user may create a user-programmable application through the interface based on one or more components or applets, as one of ordinary skill in the relevant art(s) would appreciate based on least on the teachings provided herein.

In some embodiments, the apparatus 200 may include the I/O port mentioned above, such as I/O port 114, which may directly couple the apparatus 200 to the client. In some embodiments, the I/O port 114 may be a universal serial bus, a serial bus, a parallel bus, an IEEE 1394 bus, and/or a high speed interconnect of proprietary design which allows for the transfer of information between the client and the apparatus 200.

In some embodiments the apparatus 200 may include optional components, such as, but not limited to, a local input module 124 may be included to receive data or commands from the user. In some embodiments, the local input 124 may be a keyboard or an on/off switch. The apparatus 200 may also include an optional status indicator 126 to show the current state of the system, such as, for example, that the apparatus 200 is on. Moreover, the apparatus 200 may include an optional display 128 to show at least current and/or historical usage information.

In some embodiments, a clock 130 may be included to provide timing information to the apparatus 200. According to some embodiments, the clock 130 may be secure from tampering and/or unauthorized external influence.

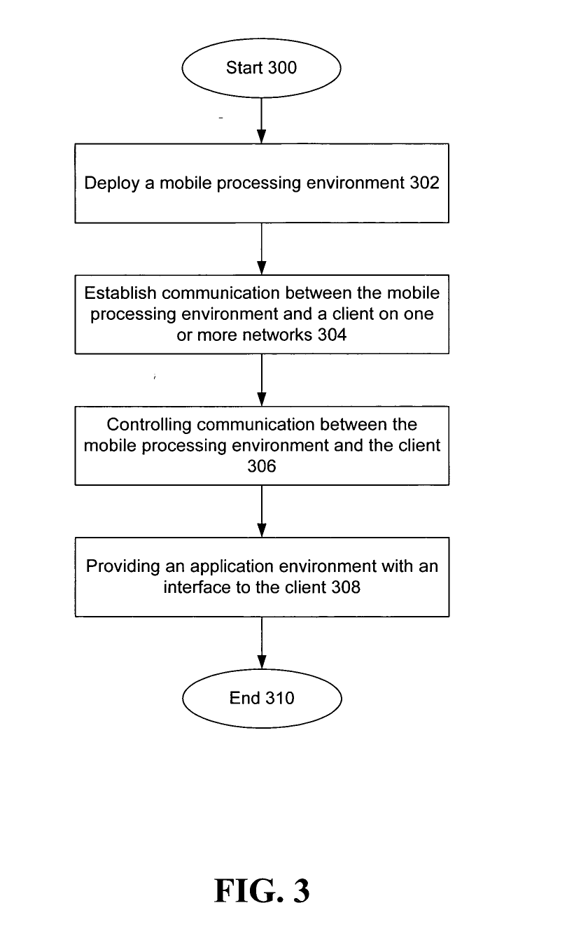

FIG. 3 illustrates a flowchart for mobile processing, according to some embodiments of the invention. The flowchart may begin operations at start 300 and proceed to 302, where it may deploy a mobile processing environment in a housing including a processor module to execute one or more processes, wherein the processor module includes one or more cores, according to some embodiments. In some embodiments, the operation may then proceed to 304, where it may establish communication with a transceiver between the apparatus and a network.

The process may then proceed to 306, where it may control communication to the network with a communications module at the apparatus, according to some embodiments. The process may then proceed to 308, where, according to some embodiments, it may provide an application environment with an interface to a client by request received on the network. In some embodiments, the interface provides the client with an application operable on the apparatus without installing the application on the client and data retrieved from the apparatus. The process may then proceed to 310 where it ends, and is free to operate any of the operations 302, 304, 306, or 308, as one of ordinary skill in the relevant art would appreciate based at least on the teachings provided herein.

In some embodiments, the deploying 302 may include the powering on of the apparatus, such as apparatus 100 or 200; initiating the components and logic of the apparatus; receiving authentication of identity from the user; or verifying the current time from the clock.

According to some embodiments of the invention, the establishing of communication 304 may include discovering one or more networks available to the apparatus; discovering one or more clients available to the apparatus; confirming the location and/or status of the apparatus; or connecting to the one or more networks or clients.

In some embodiments of the invention, the controlling communication 306 may include monitoring information traffic to and from the apparatus; and/or managing the information traffic between the apparatus and one or more clients, one or more networks, or other devices like the apparatus.

According to some embodiments of the invention, the providing of the application environment 308 may include configuring one or more interfaces; instantiating one or more applications based on requests received from one or more clients; managing the transfer of data to and from the apparatus.

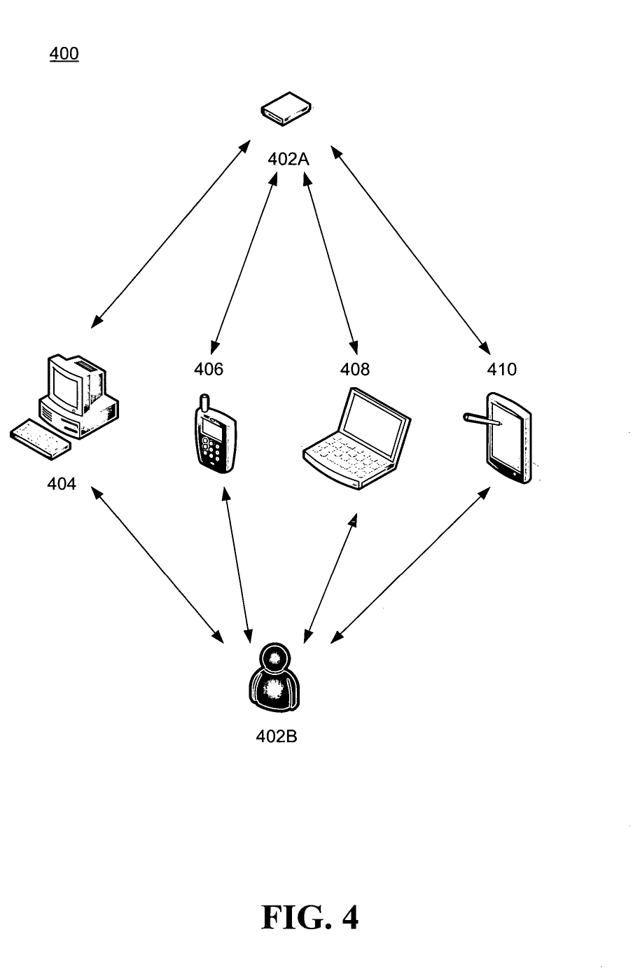

FIG. 4 illustrates a mobile processing system, client devices, and a user in a usage model, according to some embodiments of the invention. In some embodiments, the mobile processing system 400 may include an apparatus 402A, such as, but not limited to apparatus 100 or 200, paired with a user 402B. The user 402B may interoperate with the apparatus 402A through one or more clients, such as, but not limited to the computer devices 404, 406, 408, or 410, according to some embodiments of the invention.

In some embodiments, the clients may be a personal computer (PC) 404, a telephone 406, a laptop 408, or a PDA 410. As one of ordinary skill in the relevant art(s) would appreciate, based at least on the teachings provided herein, each of the clients may have specialized usage models and capabilities. The addition of the apparatus 402A, according to some embodiments, provides increased capabilities to all of these clients, while simultaneously providing the user 402B with access to his/her own data and applications.

In some embodiments, the apparatus of the invention may be implemented in a hospital environment. In the hospital environment, a patient, nurse, and/or doctor may each have an apparatus, such as the apparatus 100 or 200. In some embodiments, each user may be able to interface with one or more clients to share information and access computing devices in various locations, such as, but not limited to, the patient room, an operating room, an x-ray room, etc., while simultaneously maintaining access to their own information, such as, but not limited to, treatment or health records, available at all times.

For example, in some embodiments, the apparatus of a nurse may travel around the hospital with the nurse, from room to room, and the clients in each room may be computing devices or diagnostic devices through which the nurse may access the apparatus; retrieve applications or data from the apparatus; update the applications or data on the apparatus, for example, with new data regarding a patient; and/or upload the data to other apparatuses or clients.

Similarly, with respect to other environments, such as schools, homes, and offices, some embodiments of the invention may be implemented to allow users persistent and consistent access to their applications and data.

Embodiments of the present invention may be described in sufficient detail to enable those skilled in the art to practice the invention. Other embodiments may be utilized, and structural, logical, and intellectual changes may be made without departing from the scope of the present invention. Moreover, it is to be understood that various embodiments of the invention, although different, are not necessarily mutually exclusive. For example, a particular feature, structure, or characteristic described in one embodiment may be included within other embodiments. Those skilled in the art can appreciate from the foregoing description that the techniques of the embodiments of the invention can be implemented in a variety of forms. Therefore, while the embodiments of this invention have been described in connection with particular examples thereof, the true scope of the embodiments of the invention should not be so limited since other modifications will become apparent to the skilled practitioner upon a study of the drawings, specification, and following claims.

What is claimed is:

1. An apparatus comprising:
a housing to deploy a mobile processing environment including a processor module to execute one or more processes, wherein the processor module includes one or more cores;
a transceiver to establish communication between the apparatus and a network;
a communications module to control communication between the apparatus and the network; and
an application environment to provide an interface to a client by request received on the network, wherein the interface provides the client with an application operable on the apparatus without installing the application on the client and data retrieved from the apparatus.

2. The apparatus of claim 1, wherein the one or more processes include the interface, the application, and/or requests to retrieve or modify the data.

3. The apparatus of claim 1, wherein the network is the Internet, a cellular telephone network, a local area network, and/or a wide area network.

4. The apparatus of claim 1, wherein the interface provides a web server using at least hypertext markup language to converse with the client.

5. The apparatus of claim 1, wherein one or more components of the application are downloadable to the client from the apparatus.

6. The apparatus of claim 1, wherein the client is cellular telephone, a personal digital assistant, a laptop computer, a desktop computer, or a network appliance.

7. The apparatus of claim 1, wherein a user uses the client to access and manage the apparatus.

8. The apparatus of claim 1, wherein the communications module authenticates a user's identity prior to providing the interface.

9. The apparatus of claim 1, wherein the interface includes a file transfer and/or synchronization interface.

10. The apparatus of claim 1, further comprising:
an input/output control hub to manage information transmitted to and received from the processor module.

11. The apparatus of claim 1, further comprising:
a battery within the housing to provide power to the apparatus.

12. The apparatus of claim 1, further comprising:
a power adapter within the housing to provide power to the apparatus and/or the battery, wherein the power adapter is capable of receiving power from an external power supply.

13. The apparatus of claim 1, further comprising:
an input/output port to directly couple the apparatus to the client.

14. The apparatus of claim 13, wherein the input/output port is a universal serial bus, a serial bus, a parallel bus, an IEEE 1394 bus, and/or a high speed interconnect.

15. The apparatus of claim 1, further comprising:
a local input module to receive data or commands;
a status indicator to show the current state of the apparatus; and
a display to show at least current and/or historical usage information.

16. The apparatus of claim 15, wherein the local input is a keyboard or an on/off switch.

17. The apparatus of claim 1, further comprising:
a clock to provide timing information to the apparatus.

18. The apparatus of claim 17, wherein the clock is secure from tampering and/or unauthorized external influence.

19. The apparatus of claim 1, further comprising:
a memory module to provide storage for the application and data.

20. The apparatus of claim 1, further comprising:
an antenna coupled to the transceiver to increase reception and transmission of the apparatus.

21. A method comprising:
deploying a mobile processing environment in a housing including a processor module to execute one or more processes, wherein the processor module includes one or more cores;
establishing communication with a transceiver between the apparatus and a network;
controlling communication to the network with a communications module at the apparatus; and
providing an application environment with an interface to a client by request received on the network, wherein the interface provides the client with an application operable on the apparatus without installing the application on the client and data retrieved from the apparatus.

22. The method of claim 21, wherein the one or more processes include the interface, the application, and/or requests to retrieve or modify the data.

23. The method of claim 21, wherein the network is the Internet, a cellular telephone network, a local area network, and/or a wide area network.

24. The method of claim 21, wherein the interface provides a web server using at least hypertext markup language to converse with the client.

25. The method of claim 21, wherein one or more components of the application are downloadable to the client from the apparatus.

26. The method of claim 21, wherein the client is cellular telephone, a personal digital assistant, a laptop computer, a desktop computer, or a network appliance.

27. The method of claim 21, wherein a user uses the client to access and manage the apparatus.

28. The method of claim 21, wherein the communications module authenticates a user's identity prior to providing the interface.

29. The method of claim 21, wherein the interface includes a file transfer and/or synchronization interface.
